(19) United States
(12) Patent Application Publication
(10) Pub. No.: US 2017/0372700 A1
(43) Pub. Date: Dec. 28, 2017

(54) METHOD OF ENTERING DATA IN AN ELECTRONIC DEVICE

(71) Applicant: YANDEX EUROPE AG, Luzern (CH)

(72) Inventors: Evgeny Mikhailovich VOLKOV, Moscow (RU); Denis Sergeevich PHILIPPOV, Moscow (RU); Ilia Alekseevich MELNIKOV, Reutov, Moscow region (RU)

(21) Appl. No.: 15/525,614

(22) PCT Filed: May 22, 2015
(86) PCT No.: PCT/IB15/53789

§ 371 Date: May 10, 2017

(30) Foreign Application Priority Data
Jan. 27, 2015 (RU) 2015102279

(51) Int. Cl. G10L 15/26; G06F 17/30; G06F 17/21

(52) U.S. Cl. CPC G10L 15/26; G06F 17/218; G06F 17/30752

(57) ABSTRACT

A method of entering data in an electronic device comprises receiving a voice request via a voice interface of the electronic device and obtaining a plurality of tags, each tag associated with a respective entry field of a user interface for an application of the electronic device. The device obtains at least one text portion associated with a respective tag derived from the voice request by converting the voice request into text; analyzing the text to provide at least one text portion; and associating at least one text portion with a respective tag of the plurality of tags. At least one entry field of the application is filled in with a respective text portion associated with the respective tag associated with the entry field.

### CROSS-REFERENCE

The present application claims priority to Russian Patent Application No. 2015102279, filed Jan. 27, 2015, entitled “A METHOD OF ENTERING DATA IN ELECTRONIC DEVICE” the entirety of which is incorporated herein.

### FIELD

The present technology relates to a method of entering data in an electronic device.

### BACKGROUND

Speech-to-text conversion is well known. Typically, a user of an electronic device incorporating a microphone enables the microphone and an audio signal for a portion of speech is captured and provided to a speech recognizer. The speech recognizer then returns a string of text either to an operating system of the electronic device or an application running on the electronic device.

Speech recognition is still regarded as being a processor intensive activity and even in modern smartphones or tablets, it is common to use a remote server running a speech recognition engine for the purposes of speech recognition. Thus for example, providers including Google and Yandex provide speech recognition servers (see http://api.yandex.com/speechkit/) which are accessible via respective APIs.

An application or operating system running on a network enabled remote electronic device can provide a captured audio signal to a speech recognition server which then returns a string of text for use by the application or operating system, for example, to populate a message field in a messaging application, to obtain a translation of the user's speech into another language, to form the basis for a search query or to execute any operating system command.

Examples of such technology include U.S. Pat. No. 8,731,942, Apple which describes the operation of a digital assistant known as Siri. U.S. Pat. No. 8,731,942 is concerned with maintaining context information between user interactions. The digital assistant performs a first task using a first parameter. A text string is obtained from a speech input received from a user. Based at least partially on the text string, a second task different from the first task or a second parameter different from the first parameter is identified. The first task is performed using the second parameter or the second task is performed using the first parameter.

US 2014/0163983, LG discloses a method for displaying a voice converted to text within a display means of a device, wherein the processor provides a text preview interface displaying at least a part of the text in the display unit, in response to a first user input, and provides a text output interface displaying the text in the display unit, in response to a second user input.

Another common form of user interaction with an electronic device comprises form filling, either within a dedicated application or within a web application running in a web browser.

While some browsers or browser agents provide auto-fill functionality allowing previously stored user details to populate tagged fields in a form, users typically do not use voice input for form filling.

This is because in order to interact with and complete an extensive application interface including a number of entry field portions with voice input, a user would typically need to manually select whichever entry field they wished to fill and then dictate text for that entry field. So, the user selects entry field A, fills this using voice input, then selects entry field B and fills this and so on. As will be appreciated, this is burdensome.

The term entry field covers not only text entry fields, where a user enters free text into a text box, for example to enter a name or address field, but any other user interface portion through which a user might input information into an application including check boxes, radio buttons, calendar widgets or drop down menus.

It will be seen that in each of these other examples, selecting the entry field and attempting to dictate a command at the very least might not be intuitive, if indeed, not possible.

### SUMMARY

In accordance with a first broad aspect of the present technology, there is provided a method of entering data in an electronic device comprising receiving a voice request via a voice interface of the electronic device; obtaining a plurality of tags, each tag associated with a respective entry field of a user interface for an application of said electronic device; obtaining at least one text portion associated with a respective tag derived from said voice request; and filling in at least one entry field of said application with a respective text portion associated with the respective tag associated with the entry field.

In accordance with a second aspect there is provided a method of processing a voice request comprising: receiving a voice request via a voice interface of an electronic device; obtaining a plurality of tags, each tag associated with a respective entry field of a user interface for an application of said electronic device; converting the voice request into text; analyzing the text to provide at least one text portion; associating at least one text portion with a respective tag of the plurality of tags; and transmitting to the electronic device the at least one text portion with an indication of the associated tag.

In further aspects, there is provided an electronic device operable to provide the first broad aspect and a server operable to provide the second aspect.

In still further aspects there are provided a system comprising a server providing the second aspect in communication via a network with a plurality of electronic devices according to the first aspect.

A computer program product comprising executable instructions stored on a computer readable medium which when executed on an electronic device are arranged to perform the steps of the first aspect is also provided.

A computer program product comprising executable instructions stored on a computer readable medium which when executed on a sever are arranged to perform the steps of the second aspect is also provided.

The technology relates to the field of handling a user voice request to fill in application user interface portions using Natural language Understanding (NLU) of text which has been recognized from a voice request of the user. The technology enables the user to fill an application's interface with their voice without necessarily manually selecting which portion of the interface they would like to fill with their voice.

The technology involves creating and matching tags for user interface portions of an application with a natural language voice request from a user to automatically fill the interface portions of the application with text portions obtained from the natural language voice request.

In the context of the present specification, unless expressly provided otherwise, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless expressly provided otherwise, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as a electronic device in the present context is not precluded from acting as a server to other electronic devices. The use of the expression “a electronic device” does not preclude multiple electronic devices being used in receiving/sending, carrying out or causing to be carried out any task or request, or the consequences of any task or request, or steps of any method described herein.

In the context of the present specification, unless expressly provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, unless expressly provided otherwise, the expression “component” is meant to include software (appropriate to a particular hardware context) that is both necessary and sufficient to achieve the specific function(s) being referenced.

In the context of the present specification, unless expressly provided otherwise, the expression “computer usable information storage medium” or simply “computer readable medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Various embodiments will now be described, by way of example, with reference to the accompanying drawings, in which:

FIG. 1 illustrates schematically a system including an electronic device for processing user voice requests, the device being implemented in accordance with non-limiting embodiments of the present technology;

FIG. 2 shows a first example of portion of a web page including a number of entry fields;

FIG. 3 shows a second example of portion of a web page including a number of entry fields;

FIG. 4 shows a second page a web application including a number of entry fields and following the web page of FIG. 2;

FIG. 5 is a flow diagram illustrating the processing performed by an agent within the system of FIG. 1; and

FIG. 6 is a flow diagram illustrating the processing performed by a speech-to-text server within the system of FIG. 1.

### DESCRIPTION OF THE EMBODIMENTS

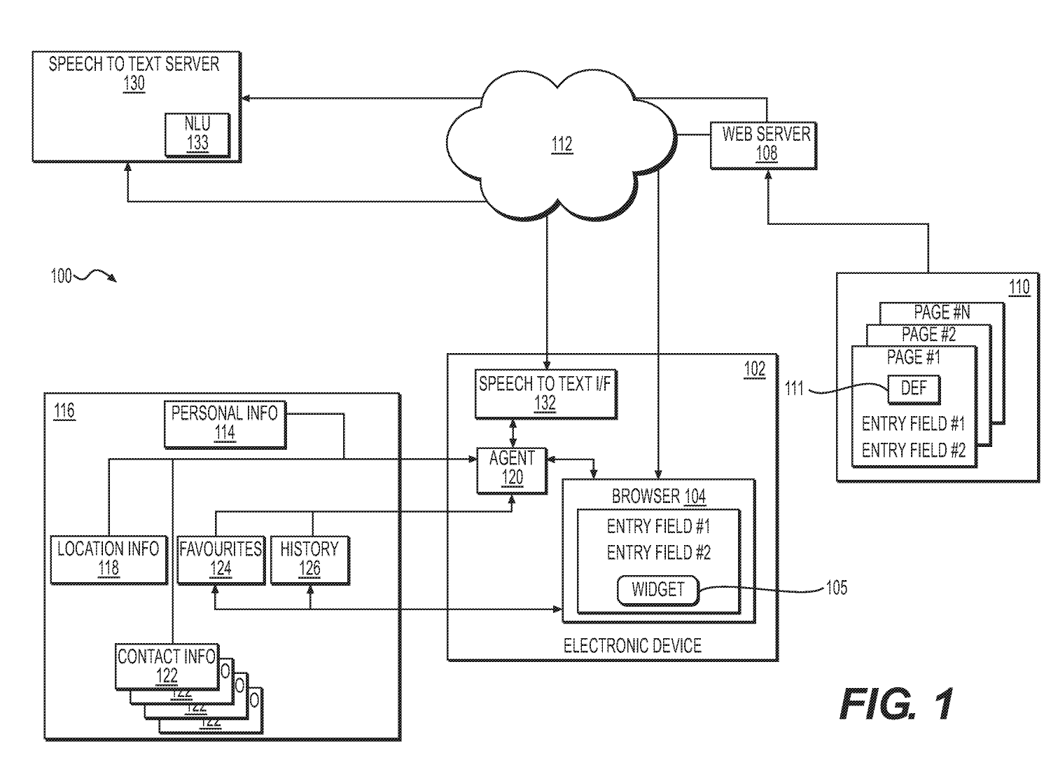

Referring to FIG. 1, there has been shown a diagram of a system 100. It is to be expressly understood that the system 100 is merely one possible implementation of the present technology. Thus, the description thereof that follows is intended to be only a description of illustrative examples of the present technology. This description is not intended to define the scope or set forth the bounds of the present technology. In some cases, what are believed to be helpful examples of modifications to computer system 100 may also be set forth below.

This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances a simple implementation of the present technology, and that where such is the case they have been presented in this manner as an aid to understanding. As persons skilled in the art would understand, various implementations of the present technology may be of a greater complexity.

Within the system 100, there is provided an electronic device 102. The implementation of the electronic device 102 is not particularly limited, but as an example, the electronic device 102 may be implemented as a personal computer (desktops, laptops, netbooks, etc.) or a wireless electronic device (a cell phone, a smartphone, a tablet and the like). The general implementation of the electronic device 102 is known in the art and, as such, will not be described here at much length. Suffice it to say that the electronic device 102 comprises a user input interface (such as a keyboard, a mouse, a touch pad, a touch screen, a microphone and the like) for receiving user inputs; a user output interface (such as a screen, a touch screen, a printer and the like) for providing visual or audible outputs to the user; a network communication interface (such as a modem, a network card and the like) for two-way communication over a communications network 112; and a processor coupled to the user input interface, the user output interface and the network communication interface, the processor being configured to execute various routines, including those described herein below. To that end the processor may store or have access to computer readable commands which commands, when executed, cause the processor to execute the various routines described herein.

The present example is described in terms of filling entry fields displayed within a web application running on a browser 104 within the electronic device 102. As is known, the web application comprise a number of HTML (hyper-text markup language) pages, Pages #1 . . . Page #N, interlinked by hyperlinks and these are retrieved by the browser 104 from a web server 108 using each page's given URL (Uniform Resource Locator), typically across the network 112 (although in some cases, the pages could be stored locally with the URL pointing to a local storage location), before being rendered.

In the present example, at least one page of the application includes a number of entry fields, only two from Page #1 are shown: Entry Field #1 and Entry Field #2. As discussed earlier, each entry field can comprise any form of user interface portion through which a user might input information into an application including: text entry fields, check boxes, radio buttons, calendar widgets or drop down menus. Once the entry fields are completed, a user typically selects a widget, such as a button 105 incorporated within the page to enable the data supplied by the user to be posted to the web server 108 and for the next page of the application to be supplied by the web server 108 to the electronic device 102 in response.

Pages #1 to #N can either comprise static pages which have been explicitly designed by an author and then published by transmitting the generated HTML for such pages to a storage location 110 accessible to the web server 108. Alternatively or in addition, individual pages can be generated dynamically based on a combination of a page template, a user query and externally retrieved information as is typical for example for a catalog, shopping or booking site.

In a simplest implementation, entry fields are associated with tags indicating semantically the information which is to be entered into a web page. A simple example of such tagging for a portion of web page HTML comprising a form where a user is to enter their first name and last name is as follows:

<form action=“demo_form.asp”>
First name: <input type=“text” name=“FirstName” value=“Mickey”><br>
Last name: <input type=“text” name=“LastName” value=“Mouse”><br>
<input type=“submit” value=“Submit”>
</form>

Typically, the tags for the entry fields are defined by the application author using their publishing software as the page is being designed and entry fields added by the author. In alternative non-limiting embodiments of the present technology, the tags can be assigned at a point in time after creation of the page.

In the prior art, when viewing a rendered version of this HTML within a browser, a user with a voice enabled electronic device could select the text entry field labelled FirstName and dictate their first name; and then select the text entry field labelled LastName before dictating their last name and then click on the submit button before proceeding to the next page. Alternatively, where the user had stored their personal information 114 suitably tagged in storage 116 accessible to the electronic device 102, some browsers can obtain this information and auto-fill entry fields with tags corresponding to those stored for the user.

However, as discussed earlier, the first technique is frustrating for users and is little used; whereas the second is of limited use, especially where the entry fields require information other than pre-stored personal data, for example, a hotel name or destination location only specified by a user in a voice request.

In the illustrated example, an agent 120 is provided on the electronic device 102, either to run as a stand-alone process or as a browser plug-in or indeed as an operating system process. The agent 120 acquires audio signals corresponding to user voice requests from a microphone component of the electronic device 102 and in the present example supplies this to a remote Speech-to-Text server 130 via a Speech-to-Text interface 132 made available by the speech-to-text server 130 on the electronic device 102. Examples of a Speech-to-Text interface 132 which could be extended to implement the present technology include Yandex Speech Kit API referred to above.

In the present example, the speech-to-text server 130 not alone returns text corresponding to the audio signal supplied by the agent 120 through the interface 132 as with the present Yandex Speech Kit API, but breaks down the text into individual portions, each associated with a labelled or named entry field of the application.

In order to assist the speech-to-text server 130 in doing so, the speech-to-text server 130 accesses the page information for the application to determine the labels or names for the application entry fields.

One technique for doing so involves the agent 120 providing, along with the audio signal for the voice request, an application identifier, for example, the URL for the current page from the browser 104. In this case, the speech-to-text server 130 can obtain a copy of the page from the web server 108 hosting the page and then parse the page to determine the entry fields required by the page. Alternatively, the agent 120 could supply the entry field tag information to the speech-to-text server 130 directly. It is possible for the agent 120 to extract this information either from the web page HTML or alternatively from the DOM (Document Object Model) generated by the browser 104 when rendering the web page.

In the simple FirstName/LastName example provided above, the speech-to-text server 130 would see that the page required a first name and a last name and so endeavours to locate within the audio signal provided by the agent 120, a first name and a last name.

This is relatively simple if the user when viewing the web page on their browser simply states their name. However, the user could equally dictate “Enter my details”. Now using a natural language understanding (NLU) component 133 either incorporated within the speech-to-text server 130 or cooperating with the speech-to-text server 130, the speech-to-text server 130 can identify that the user's details are required for a page which in turn requires the user's first name and last name.

It is unlikely, for a remote speech-to-text server 130 which might be servicing requests from a large number of disparate electronic devices controlled by different users, that the speech-to-text server 130 would have direct access to the users' personal details and so in such a case, the speech-to-text server 130 could return to the agent 120 a pair of tags <FirstName>; <LastName> with null associated text, so prompting the agent 120 to retrieve the user's first name and last name from their stored personal information 114 and to populate the entry fields accordingly.

On the other hand, where the user had dictated a name, possibly their own name, for example, “Lars Mikkelsen”, the speech-to-text server 130 would return tagged text for example in the form “Lars”<FirstName>; “Mikkelsen”<LastName> enabling the agent 120 to populate the page entry fields directly.

Using the NLU component 133 along with knowledge of the entry fields which are to be populated enables the speech-to-text server 130 to handle more complex tasks.

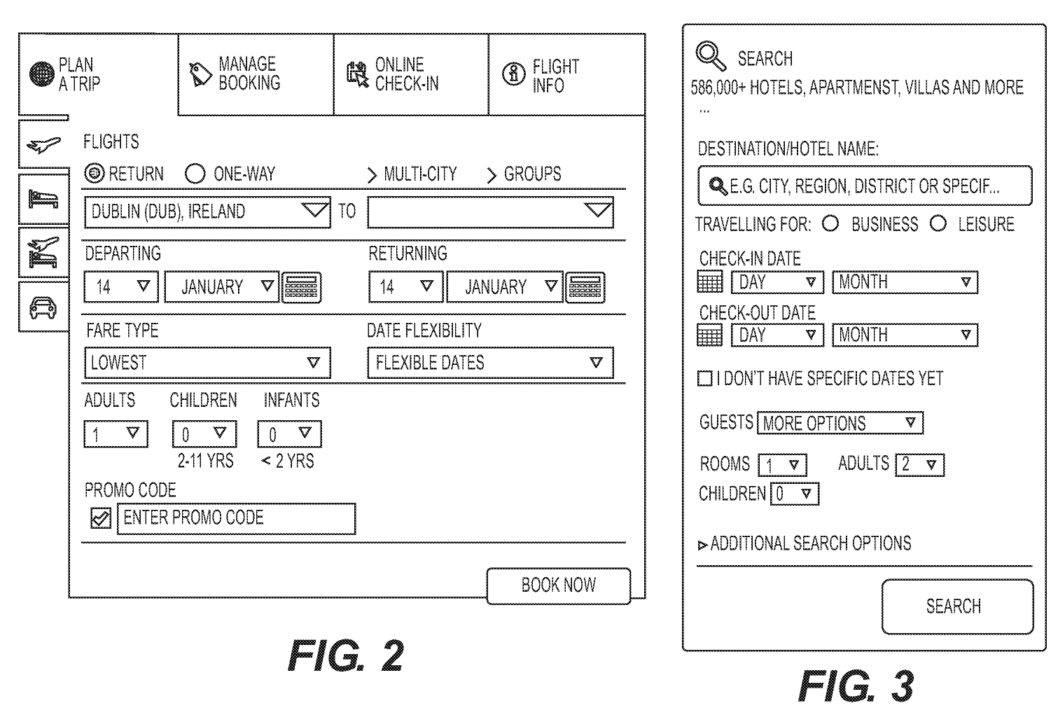

So when a user is faced with a page such as illustrated in FIG. 2 comprising a flight booking form, they might dictate “Book me a flight to Munich on 22 February” or an equivalent natural language expression. In this case, the speech-to-text server 130 on retrieving the page will identify a number of entry fields which could be labelled or tagged: <Return><One Way><StartLocation><DestinationLocation><DepartureDay><DepartureMonth><ReturnDay><ReturnMonth><FareType><DateFlexibility><NoAdults><NoChildren><No Infants><PromoCode>. The default date and number of adult, children and infant values shown in FIG. 2 could also be retrieved by the speech-to-text server 130. (The multi-city option might also be tagged and an exemplary use of this tag is described below.)

Then, using the NLU component 133, the speech-to-text server 130 can return to the agent the following tagged text in response to the above user's voice request: “False” <Return>; “True”<One Way>; “Dublin”<StartLocation>; “Munich”<DestinationLocation>; “22”<DepartureDay>; “February”<DepartureMonth>; <ReturnDay>; <ReturnMonth>; <FareType>; <DateFlexibility>; “1”<NoAdults>; “0”<NoChildren>; “0”<No Infants>;

<PromoCode>.

It will be noted that some of the returned tags have a null value for associated text, for example, <PromoCode>. If the agent 120 searches stored information for the user within the storage 116, they are likely not to find any useful information tagged as <PromoCode> and so this field will remain unfilled.

In the case of the <StartLocation> field, the default value of “Dublin” from the original page has been provided by the speech-to-text server 130. If however, this field had been blank in the original web page or if the speech-to-text server 130 were programmed to provide null text for such a field i.e. leave such a field blank, when only default information was otherwise available from the original web page and not specified in the voice request as above, then the speech-to-text server 130 could return the tag with a null value.

In this case, the agent 120 would be prompted to attempt to use location information 118 acquired for example from a GPS receiver (not shown) incorporated within the electronic device 102; or simply to use the user's home address from their personal information 114 to populate the field labelled <StartLocation>.

With the various fields filled, the user can if they wish complete any remaining fields or edit any of the fields automatically filled by the agent 120 before pressing the “Book Now” button.

In a second example, as illustrated in FIG. 3, a user is viewing a hotel booking form rendered by the browser 104. In this case, the user might dictate “Book a hotel in Milan for my family for three nights from 22 March”.

Again the speech-to-text server 130 obtaining the page information would recognise a number of labels for the entry fields, for example, as follows: <Destination>; <CheckInDay>; <CheckInMonth>; <CheckOutDay>; <CheckOutMonth>; <NoRooms>; <NoAdults>; <NoChildren>.

Using the NLU component 133, the speech-to-text server 130 would therefore return the following tagged text: “Milan”<Destination>; “22”<CheckInDay>; “March” <CheckInMonth>; “25”<CheckOutDay>; “March”<CheckOutMonth>; “1”<NoRooms>; <NoAdults>; <NoChildren>.

In this case, where the speech-to-text server 130 had recognised that the request was to book a room for the user's family, it could signal to the agent that it should seek the user's family information by not using the default values of 2 and 0 from <NoAdults> and <NoChildren> so forcing the agent 120 to look for this information in the storage 116.

In this case, the agent 120 could operate in a number of ways. For example, electronic devices such as the electronic device 102 typically store user's contact information 122 comprising a number of records, each storing contact names, phone numbers, e-mail addresses etc. It is also possible to specify the nature of each contact's relationship with the user, for example, child, spouse, parent etc. Other sources of this information include any social networks to which the user belongs including Facebook and this network information can often include the semantics of contact's relationship with the user so allowing the agent to determine for example the details of the user's family for inclusion in forms to be filled.

Using this information, it is possible for the agent 120 to determine the members of a user's family and to for example, provide values for each of the <NoAdults> and <NoChildren> fields.

Now with the information provided by the speech-to-text server 130 and determined by the agent 120, the agent 120 can populate the various fields of the form, so allowing the user to click “Search” when they are satisfied the information is correct.

In summary, the single page examples of FIGS. 2 and 3 require an application author to describe entry fields of their application interface with respective tags. When a user interacts with the application by dictating a request, for example, “Book Ritz hotel for 2 nights from the December 1”, the application (possibly via an agent 120) sends the audio signal comprising the voice request to a speech-to-text server 130. On receiving the request and obtaining the tag information for the page, the speech-to-text server 130 transforms the audio to text portions and associates text portions with respective tags. For example, “Ritz hotel” is associated with a <hotel> tag, “1 December” associated with a <date> tag etc. The speech-to-text server 130 then sends tagged text portions to the application (again possibly via an agent 120). The application receives the text portions and these are entered into respective interface portions according to the assigned tags. As a result, the user has (based on a single voice request) filled various interface portions.

It will be appreciated that while the above example has been described in terms of a web application, the technology could equally be implemented within a native code, stand-alone or client-server application. In this case, instead of comprising a sequence of web pages, the application might display a sequence of screens and so semantic information for relevant entry fields of such screens would need to be available to any agent responsible for automatically filling those entry fields in response to a user voice request.

The technology could also be implemented within an app i.e. a software application for a mobile device running, for example, Apple™ iOS or Google™ Android OS.

Alternatively, the technology could be implemented in conjunction with general-purpose software including for example, an email client such as Microsoft™ Outlook, a word processor such as Microsoft™ Word or a spreadsheet application such as Microsoft™ Excel where it could be useful to automatically populate entry fields in, for example, an e-mail message, document or spreadsheet. In this case, an agent, such as the agent 120, could detect tags associated with entry fields in the page being displayed by the general purpose application, for example, by extracting the information via an API for the application and subsequently populate the fields with text portions extracted from a voice request through the API for the application as described above.

In any case, the agent functionality could be integrated within the application or indeed remain as a discrete component or operating system component.

Similarly, while the speech-to-text server 130 has been described as a single remote server serving many client devices such as the electronic device 102, the speech-to-text server 130 could equally be implemented as a component of the electronic device 102.

The present technology can also be applied for filling entry fields for an application extending across a number of linked pages. In this case, an application author defines a workflow indicating the sequence of pages comprising the application and which entry fields occur on those pages. In the example of FIG. 1, this workflow definition 111 is stored within the content of the first page, for example, Page #1 of an application, in a manner readily identifiable to either a speech-to-text server 130 or in some cases, an agent 120, if the agent supplies the workflow definition 111 to the speech-to-text server 130. So for example, the workflow definition 111 can be included as a fragment of XML (eXtended Markup Language) as a non-rendered header portion of the HTML for a web page. As well as including the workflow definition 111, each of these entry fields is tagged within the HTML for the page, as described above.

The workflow definition 111 can comprise a simple listing of pages and, for each page, a respective set of identifiers for the entry fields contained in the page. Thus these sets of identifiers could simply comprise the tags for respective entry fields; or the sets of identifiers could comprise both the tags and entry field information for example, in the form provided in the FirstName/LastName example above. If required, the workflow definition 111 can also include logic specifying different sequences of pages within the application determined according to the user input. XML grammar is readily designed to incorporate such conditional logic.

As before, the agent 120 obtains the audio signal for a voice request and supplies this via the speech-to-text interface 132 along with an application identifier, e.g. a URL for the first page, to the speech-to-text server 130.

The speech-to-text server 130 initially analyzes the voice request and performs basic speech to text to obtain the text input.

The speech-to-text server 130 then cuts the text into portions and, in conjunction with the NLU component 133, transforms the text portions as required to make them most compatible with the entry fields, for example, converting a request for “3 nights accommodation” to start and end dates as in the example above, before assigning text portions to respective tags.

Where a workflow definition 111 is available for an application, the speech-to-text server 130 can deduce the text portions best matching entry fields within the workflow across a number of application pages. It will be appreciated that having a view of the entry fields which might be required for subsequent pages is especially useful for dealing with a voice request which has been provided when the user is looking at a first page of an application.

Once the tagged values for entry fields have been determined by the speech-to-text server 130, they are returned to the electronic device 102, either on a page-by-page basis or for the set of pages comprising the application.

On receiving the tagged values and optionally obtaining any further information available to the electronic device 102 from storage 116 as described above, the application entry fields are filled.

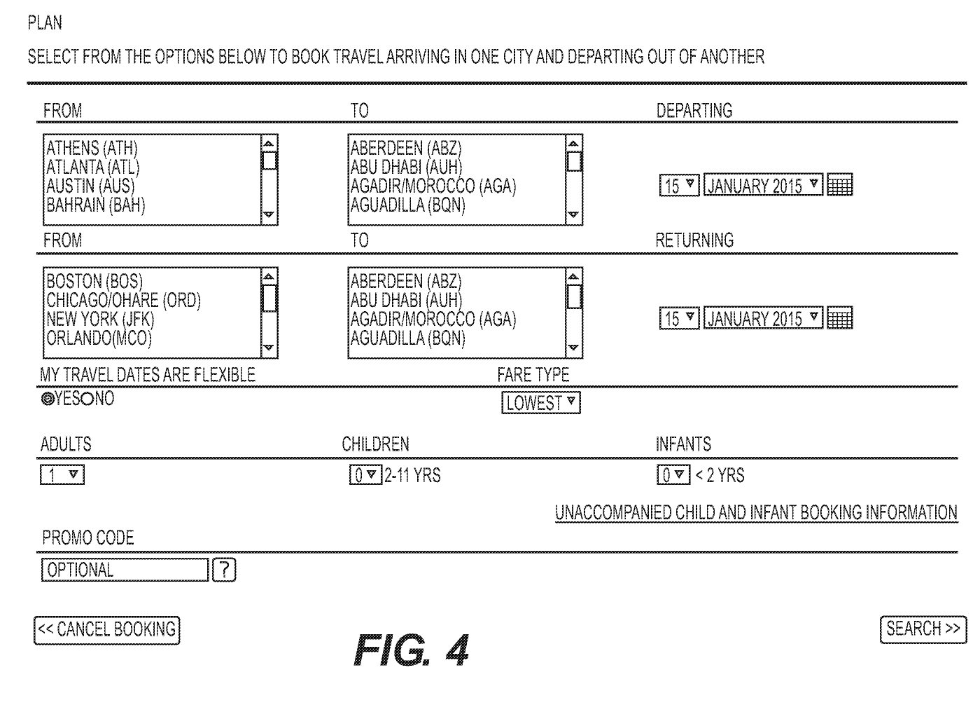

As a worked example of a multi-page application, beginning at the form shown in FIG. 2, if a user selects the multi-city option, they would be brought to a second page, such as shown in FIG. 4, instead of when they only require a simple return or one-way flight.

A workflow definition 111 which might enable user interaction across a number of pages of this application might respond to a user request “Book me a flight from London to New York via Paris on 22 March”.

Now with an application workflow definition 111 specifying the fields available on the first page of the application, shown in FIG. 2, and the fields available on the second page of the application, shown in FIG. 4, the speech-to-text server 130 can return to the agent 120 the following tagged fields for the first page:

<Return>; “True”<One Way>; “True”<Multicity>; “London”<StartLocation>; “New York” <DestinationLocation>; “22”<DepartureDay>; “March”<DepartureMonth>; <ReturnDay>; <ReturnMonth>; <FareType>; <DateFlexibility>; “1”<NoAdults>; “0”<NoChildren>; “0”<No Infants>; <PromoCode>;

On receiving this information, the agent 120 on filling in the supplied information would then cause the application to proceed to the page shown in FIG. 4.

As will be appreciated supplying the start location information and departure dates for the first page is redundant, but doing so requires less intelligence (and so less tailored code) of the speech-to-text server 130 than determining that these entry fields need not be filled.

The speech-to-text server 130 can return to the agent 120 the following tagged fields for the second page of the application, either in response to a second request from the agent 120; or in response to the original request and delineated appropriately from the tagged information for the first page:

“London”<StartLocation1>; “Paris”<DestinationLocation1>; “Paris”<StartLocation2>; “New York”<DestinationLocation2>; “22”<DepartureDay>; “March”<DepartureMonth>; <FareType>; <DateFlexibility>; “1”<NoAdults>; “0”<NoChildren>; “0”<No Infants>; <PromoCode>;

The agent 120 can now fill in the required information for the second page, allowing the user to check and/or change the information before they click the “Search” button.

Note that in this example, using the workflow definition 111, the agent 120 can cause the application to move automatically from one page of an application to another before waiting for the user to click “Search” on the second page.

Note also that text which has been derived from the voice request such as “London” and “New York” can be used with entry fields on both the first and second pages of the application. Also, text such as “Paris” has been used for more than one entry field in a single page of the application.

If the workflow definition 111 for an application is sufficiently extensive, it is possible for the agent 120 having been supplied with further tagged information for subsequent pages by the speech-to-text server 130 to fill in further information on subsequent pages. For example, if a user clicked “book” for a candidate flight listed on a page (not shown) following the page of FIG. 4, the agent 120 might then be able to fill in the user's name, address and credit card details on the subsequent page (not shown). Alternatively, if the user arrived at such a page, they could simply dictate a request “Fill in my details” and the speech-to-text server 130 would in response to being provided with the voice request and page URL, return field tags to the agent 120 to have the agent retrieve the information for these tags from storage 116 and populate the entry fields accordingly.

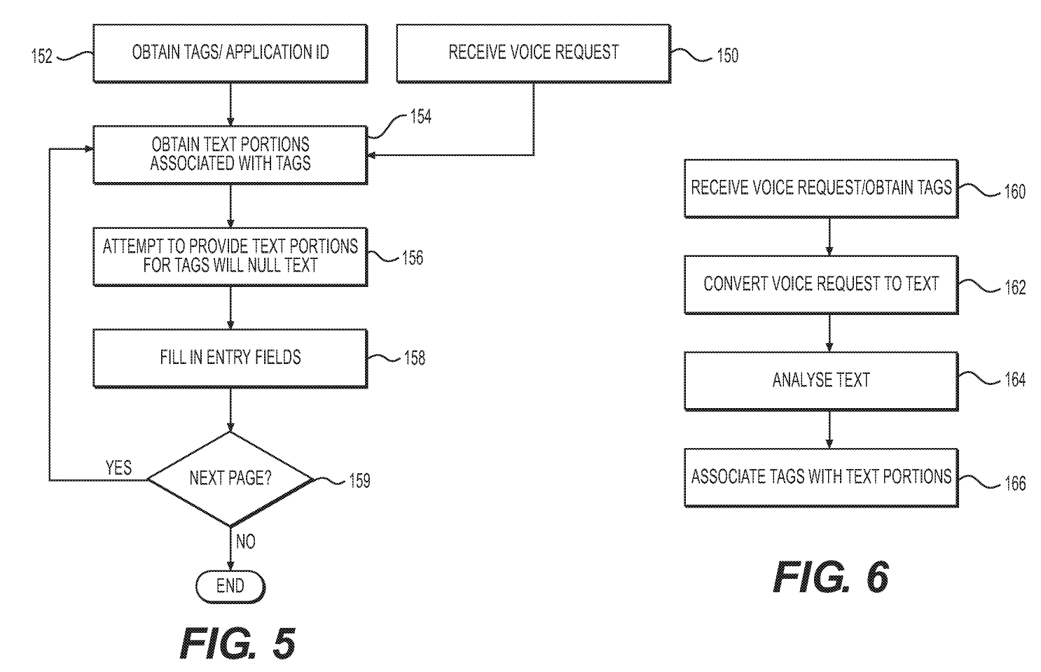

So, referring to FIGS. 5 and 6 which summarize the embodiments described above, the agent 120 obtains a voice request, step 150. Either in response to the voice request or once an application has been launched (downloaded and rendered in the case of a web application), the agent 120 either obtains the required tags for the application, either from the application pages or a workflow definition included within the application, or the agent 120 just obtains an application identifier, e.g. a URL, step 152. The agent 120 then obtains text portions derived from the voice request and associated with the tags for the application, step 154.

In embodiments where the processing for step 154 is primarily performed by a remote server 130, step 154 involves the agent 120 providing the voice request and either the application tags or a workflow definition 111 or the application identifier to the server 130.

When the server 130 obtains the voice request and the voice tags, step 160, it converts the audio signal into text, step 162. As explained, tags can either be provided by the agent 120 to the server 130 directly, or if a URL is provided, the server 130 can obtain the tags from the application pages stored on a web server or from a workflow definition 111 available on the web server. An NLU component 133 analyses the text and possibly with a knowledge of the required tags for the application, provides text portions derived from the voice request, step 164. The text portions are then associated with the tags (or vice versa) and provided to the agent 120, step 166.

When the agent 120 obtains the tagged text, it can then attempt to provide text portions for tags with null text, using semantic user information accessible to the agent 120, step 156.

The agent 120 now fills in any entry fields for which it has tagged information, step 158, and if a workflow definition 111 is available and, if required and possible, the agent 120 causes the application to proceed to the next page of the workflow, step 159. (Otherwise, the user might select the widget causing the application to proceed to the next page.) If text portions derived from the voice request are available for entry fields of the next pages, these are used to populate entry fields of the subsequent page and so on until the workflow definition is completed.

In the example shown in FIG. 1 and described above, the NLU component 133 is described as a self-contained unit responding to the voice request and applicant entry field information provided for the application. In more sophisticated implementations, the NLU component 133 can use meta-information obtained from the request or indeed other sources to provide information for application entry fields. So for example, in response to a user request to “Book a flight from Paris to Dublin”, the NLU component 133 could obtain the airport code CDG from the published list of International Air Transport Association (IATA) airport codes for inclusion with an entry field tagged <Start Airport>. Similarly, the NLU component 133, could use the TCP/IP address or even details of the electronic device type contained within the HTTP request sent by the agent 120 to the speech-to-text server 130 to determine the user's location or context to assist in providing information for application entry fields.

In one such example when operating the technology with an email client application, a user issues the voice request “Send an e-mail to Conor with a map showing the location of tonight's meeting” either when viewing the email client home screen or a blank e-mail message. In this case, where such an agent is used, the agent 120 provides the speech-to-text server 130 with the voice request and the field names for an email, for example: <From>; <To>; <Subject>; <Attach>; <Text>.

The speech-to-text server 130 could return the following tagged fields:

<From>; “Conor” <To>; “Tonight's Meeting”<Subject>; “https://www.google.ie/maps//@53.3345359,−6.2503907,16z . . . ” <Attach>; <Text>

In this case, the speech-to-text server 130 has determined from a natural language understanding of “the location of tonight's meeting”, that a link to an image of a map around the meeting location would be useful. One guess for a useful map might be centred around the location from which the requesting electronic device 102 provided the voice request. This is indicated by the TCP/IP address of the electronic device 102 and so a link to a map image around the location corresponding to the TCP/IP address can be provided either for inclusion of the map image as an attachment to the e-mail or indeed the link could be included within the text of the e-mail.

In still further embodiments of the present technology it is possible for a user of the electronic device 102 to make information available to the speech-to-text server 130 for use in generating the tagged text supplied to the agent 120 and for enabling the completion of entry fields in the electronic device 102. This information can include any user specific information including but not limited to information of the type described above such as personal information 114, location information 118, contact information 122 as well as a user's favourite web pages (bookmarks) 124 and their browser history 126.

One technique for doing so involves authenticating the user to the speech-to-text server 130 using single sign-in credentials. Examples of single sign-in credentials are known in the art and some examples include but are not limited to Yandex.Passport™ provided by the Yandex™ search engine, Google+™ single sign in, Facebook™ and the like.

In some embodiments of the present technology, the speech-to-text server 130 can receive this user specific information from a server (not depicted) responsible for handling the single sign-in credential service. In other embodiments, each of a number of services may be associated with separate log in credentials and in those embodiments, the speech-to-text server 130 can receive the user specific information from an aggregation server (not depicted) responsible for aggregating user specific information or the speech-to-text server 130 can act as such an aggregation server.

In any case, once such user specific information is available to the speech-to-text server 130, the server 130 can provide the role described above of the agent 120 in step 156 in providing user specific text for entry fields tagged as requiring semantic information specific to a user, for example, <Name>, <Address> or <Age>.

The above examples have been described in terms of an agent 120 operating with a given application, in the case of FIG. 1, a web application running within a browser 102 or any other type of dedicated or general-purpose application.

However, other implementations could operate at a still higher level as a personal assistant, either beginning from a blank or home browser screen or indeed at the operating system level.

Thus if either at the operating system viewing a device home screen or at a browser home screen, a user were to issue a voice request “Book me a flight to Berlin”, the agent 120 could relay the audio signal to the speech-to-text server 130. Now using the NLU component 133 and seeing that a specific application had not been identified in the request from the agent 120, the speech-to-text server 130 could return a simple text string “Book Flight” to the agent 120.

The agent 120 can now use information available in storage 116 to determine which application might be used to fulfill the voice request “Book Flight”. For example, a user's favourite web pages (bookmarks) 124 and their browser history 126 are typically available to applications such as the agent 120 running on the electronic device 102. These can be used to determine the airline or flight booking utility application normally used by the user. The agent 120 can now for example launch the browser at the URL for the airline or flight booking utility. Once the web page for this URL is retrieved and rendered by the browser 104, the agent 120 can now proceed as before, for example, re-sending the speech-to-text server 130 the audio signal for the original voice request along with the identity of the application, for example, the current URL. The speech-to-text server 130 can now return tagged entry fields for filling any entry fields with the web page and possibly successive web pages as before and still only requiring only a single voice request such as “Book me a flight to Berlin”.

The above examples have illustrated the technology being used to book flights, hotel rooms and send e-mails. However, it will be appreciated that many other examples are possible, for example, for filling in details for Internet shopping or service delivery or product delivery, for example, to fill in details for a pizza delivery.

In the above description, several examples of grammar have been provided, however, it will be appreciated that any equivalent of such grammar can be used in alternative implementations of this technology.

One skilled in the art will appreciate when the instant description refers to “receiving data” from a user that the electronic device executing receiving of the data from the user may receive an electronic (or other) signal from the user. One skilled in the art will further appreciate that displaying data to the user via a user-graphical interface (such as the screen of the electronic device and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as an optical connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of entering data on an electronic device, the method comprising:
receiving a voice request via a voice interface of the electronic device, wherein:
said electronic device is executing a web application comprising a plurality of web pages;
each web page of said plurality of web pages includes at least one entry field, collectively comprising a plurality of entry fields;
said plurality of web pages is associated with a workflow definition;
said workflow definition indicates: a conditional sequence of said web pages comprising said web application and, for each web page, entry fields of said plurality of entry fields located on said web page and a set of identifiers for said entry fields located on said web page, each identifier being associated with an entry field and comprising at least a tag providing a semantic description for said entry field;
obtaining a plurality of tags, each tag being associated with a respective entry field of said plurality of entry fields;
converting an audio signal of said voice request into text corresponding to said audio signal;
analyzing said text corresponding to said audio signal to provide at least a first text portion and a second text portion derived from said text;
associating said first text portion with a first tag of said plurality of tags based on a semantic description of said first tag;
associating said second text portion with a second tag based on a semantic description of said second tag;
based on said conditional sequence of said workflow definition:
filling in a first entry field of said plurality of entry fields, said first entry field being located on a first web page of said plurality of web pages, with said first text portion associated with said first tag, said first tag being associated with said first entry field; and
filling in a second entry field of said plurality of entry fields, said second field being located on a second web page of said plurality of web pages, with said second text portion associated with said second tag, said second tag being associated with said second entry field.

2.-6. (canceled)

7. A method according to claim 1, wherein said step of analyzing the text corresponding to the audio signal to provide said first text portion and said second text portion derived from said text comprises: providing said audio signal of said voice request as well as an indicator of said plurality of tags associated with respective entry fields of said web application to a speech-to-text server; analyzing said text corresponding to said audio signal by said speech-to-text server; and said speech-to-text server providing said first text portion and said second text portion derived from said text.

8. A method according to claim 7, wherein said indicator comprises at least one of: a URL for said web application and said plurality of tags.

9. (canceled)

10. A method according to claim 1, further comprising: responsive to obtaining a null text portion associated with a respective tag for an entry field of said web application, searching for semantic user information accessible at said electronic device; and responsive to obtaining said semantic user information matching said respective tag with said null text portion, filling said entry field of said application associated with said tag with said semantic user information.

11. A method according to claim 10, wherein said semantic user information comprises one of: user personal information, user contact information, user location information, user browsing history, and a user's bookmarked web pages.

12. A method of processing a voice request, the method comprising:
receiving a voice request via a voice interface of an electronic device, wherein:
said electronic device is executing a web application comprising a plurality of web pages;
each web page of said plurality of web pages includes at least one entry field, collectively comprising a plurality of entry fields;
said plurality of web pages is associated with a workflow definition;
said workflow definition indicates: a conditional sequence of said web pages comprising said web application and, for each web page, entry fields of said plurality of entry fields located on said web page and a set of identifiers for said entry fields located on said web page, each identifier being associated with an entry field and comprising at least a tag providing a semantic description for said entry field;
obtaining a plurality of tags, each tag being associated with a respective entry field of said plurality of entry fields;
converting an audio signal of said voice request into text corresponding to said audio signal;
analyzing said text corresponding to said audio signal to provide at least a first text portion derived from said text and a second text portion derived from said text;
associating said first text portion with a first tag of said plurality of tags based on a semantic description of said first tag;
associating said second text portion with a second tag of said plurality of tags based on a semantic description of said second tag;
based on said conditional sequence of said workflow definition:
determining a first entry field of said plurality of fields to be filled with said first text portion associated with said first tag, said first tag being associated with said first entry field;
determining a second entry field of said plurality of fields to be filled in with said second text portion associated with said second tag, said second tag being associated with said second entry field;
transmitting to said electronic device:
said first text portion with an indication of said first tag and said first entry field to be filled in with said first text portion; and
said second text portion with an indication of said second tag and said second entry field to be filled in with said second text portion.

13.-17. (canceled)

18. A method according to claim 12, wherein said step of analyzing said text corresponding to said audio signal comprises: using natural language understanding to provide said first text portion and said second text portion derived from said text.

19. A method according to claim 12, wherein said step of obtaining said plurality of tags comprises at least one of:
obtaining a URL for said web application from said electronic device, retrieving a web page from said URL and extracting said tags from said web page; and
obtaining said plurality of tags from said electronic device.

20.-23. (canceled)

24. A server in communication with one or more electronic devices across a communication network and operable to perform the steps of:
receiving a voice request via a voice interface of an electronic device, wherein:
said electronic device is executing a web application comprising a plurality of web pages;
each web page of said plurality of web pages includes at least one entry field, collectively comprising a plurality of entry fields;
said plurality of web pages is associated with a workflow definition;
said workflow definition indicates: a conditional sequence of said web pages comprising said web application and, for each web page, entry fields of said plurality of entry fields located on said web page and a set of identifiers for said entry fields located on said web page, each identifier being associated with an entry field and comprising at least a tag providing a semantic description for said entry field;
obtaining a plurality of tags, each tag being associated with a respective entry field of said plurality of entry fields;
converting an audio signal of said voice request into text corresponding to said audio signal;
analyzing said text corresponding to said audio signal to provide at least a first text portion and a second text portion derived from said text;
associating said first text portion with a first tag of said plurality of tags based on a semantic description of said first tag;
associating said second text portion with a second tag of said plurality of tags based on a semantic description of said second tag;
based on said conditional sequence of said workflow definition:
determining a first entry field of said plurality of fields to be filled with said first text portion associated with said first tag, said first tag being associated with said first entry field;
determining a second entry field of said plurality of fields to be filled in with said second text portion associated with said second tag, said second tag being associated with said second entry field; and
transmitting to said electronic device:
said first text portion with an indication of said associated tag and said first entry field to be filled in with said first text portion; and
said second text portion with an indication of said second tag and said second entry field to be filled in with said second text portion.

25. A system comprising a plurality of electronic devices in communication with a server according to claim 24 across a communication network, the server being configured to execute:
receiving a voice request via a voice interface of an electronic device, wherein:
said electronic device is executing a web application comprising a plurality of web pages;
each web page of said plurality of web pages includes at least one entry field, collectively comprising a plurality of entry fields;
said plurality of web pages is associated with a workflow definition;
said workflow definition indicates: a conditional sequence of said web pages comprising said web application and, for each web page, entry fields of said plurality of entry fields located on said web page and a set of identifiers for said entry fields located on said web page, each identifier being associated with an entry field and comprising at least a tag providing a semantic description for said entry field;
obtaining a plurality of tags, each tag being associated with a respective entry field of said plurality of entry fields;
converting an audio signal of said voice request into text corresponding to said audio signal;
analyzing said text corresponding to said audio signal to provide at least a first text portion and a second text portion derived from said text;
associating said first text portion with a first tag of said plurality of tags based on a semantic description of said first tag;
associating said second text portion with a second tag of said plurality of tags based on a semantic description of said second tag;
based on said conditional sequence of said workflow definition:
determining a first entry field of said plurality of fields to be filled with said first text portion associated with said first tag, said first tag being associated with said first entry field;
determining a second entry field of said plurality of fields to be filled in with said second text portion associated with said second tag, said second tag being associated with said second entry field; and
transmitting to said electronic device:
said first text portion with an indication of said associated tag and said first entry field to be filled in with said first text portion; and
said second text portion with an indication of said second tag and said second entry field to be filled in with said second text portion.
